(19) United States
(12) Patent Application Publication
(10) Pub. No.: US 2026/0238143 A1
(43) Pub. Date: Aug. 13, 2026

(54) ELECTROSTATICALLY ACTUATED DEPLOYABLE SPACE STRUCTURES

(71) Applicant: Massachusetts Institute of Technology, Cambridge, MA (US)

(72) Inventors: Zachary C. Cordero, Westwood, MA (US); Fabien Royer, Ithaca, NY (US); Jeffrey H. Lang, Sudbury, MA (US); John Zhongyuan Zhang, Cambridge, MA (US)

(73) Assignee: Massachusetts Institute of Technology, Cambridge, MA (US)

(21) Appl. No.: 19/148,070

(22) PCT Filed: Nov. 16, 2023
(86) PCT No.: PCT/US2023/080057

§ 371 Date: Jul. 15, 2025

Related U.S. Application Data
(60) Provisional application No. 63/480,103, filed on Jan. 16, 2023.

(51) Int. Cl. H02N 1/00

(52) U.S. Cl. CPC H02N 1/002

(57) ABSTRACT

An electrostatic thin-shell structure concept capable of actively controlling the shape of large area systems with minimal mass overhead and complexity is described. The structure comprises an assembly of collapsible thin-shell cells for which the cross-section follows the classical collapsible tubular mast architecture. Two conductive electrodes are added to the top and bottom flanges of the cell. An electrostatic force develops between top and bottom electrodes upon voltage application, which flattens the cross-section and causes the cell to expand longitudinally. When multiple layers of these cells are bonded to each other, the controlled differential expansion of each layer can be harnessed to cause global bending.

### CROSS-REFERENCE TO RELATED APPLICATION(S)

This application claims the priority benefit, under 35 U.S.C. 119 (e), of U.S. Application No. 63/480,103, filed Jan. 16, 2023 and titled “Electrostatically Actuated Deployable Space Structures,” which is incorporated herein by reference in its entirety for all purposes.

### GOVERNMENT SUPPORT

This invention was made with government support under FA8702-15-D-0001 awarded by the U.S. Air Force. The government has certain rights in the invention.

### BACKGROUND

Large spacecraft structures play important roles in a variety of applications including weather prediction, power generation, and space exploration. Delivering these structures to orbit involves challenging tradeoffs between precision surface geometries, resistance to deformation from on-orbit disturbances, and launch vehicle volume and mass efficiency. While rudimentary active surface control has been implemented in structures such as telescopes, this surface control has traditionally required bulky and heavy actuators for each actuation point. Accordingly, an improved solution is needed to enable large-scale precision surface deformation for structures on orbit.

### SUMMARY

Large spacecraft structures (on the order of 5 or more meters in the largest dimension) have been used for decades on orbit. However, these structures are typically launched pre-assembled and can therefore have restrictive and complex design requirements: these pre-assembled structures must be able to withstand g-forces in excess of 3 g's and are exposed to strong vibrations during launch, depressurization while exiting Earth's atmosphere, and are exposed to temperature swings of potentially hundreds of degrees Celsius.

These structures have myriad uses. For instance, large radiometry satellites can dramatically augment climate modeling capabilities and improve forecasting of natural disasters. In the energy sector, space solar power satellites can collect sunlight continuously throughout the day, convert it into microwaves and send it directly where needed on Earth, significantly mitigating energy storage and transfer shortfalls globally. Similar large space architectures may be leveraged to enable deep-space electric propulsion and the non-nuclear exploration of the outer solar system as well as large infrastructures and habitats on the Moon and on Mars. Besides very large space structures, lighter and larger apertures may be integrated in small satellites, paving the way for highly capable mega-constellations and new applications. Finally, these structures will be key enablers of future space telescopes.

Active space structures may be utilized to compensate for the effect of disturbances (e.g., thermal distortions, inertial loads, vibrations, gravity gradient, solar pressure), for example in space telescopes, increasing the limits of aperture size. However, traditional control strategies for active space structures require large and heavy actuators, and scaling these actuation methods to extremely large space structures (D>50 m) becomes extremely difficult.

Recent advances in soft robotics have focused on the development of volume- and mass-efficient actuators. One such example is artificial muscles. Various concepts have been investigated using temperature sensitive polymers, pneumatic and chemical actuation, and other physical processes. Most of these solutions cannot be used in space since they are extremely sensitive to the environment in which they are operated. However, the inventors have recognized that electrostatic actuation may provide a solution combining volume and mass efficiency, customizability, scalability, and durability required for harsh on-orbit applications.

Electrostatic actuation has been investigated to control the shape of large space antennas and flexible mirrors; however, these technologies have traditionally required a stiff command surface electrode which is challenging to integrate in lightweight deployable structures. Accordingly, the present technology is directed toward a thin-shell electrostatic structure concept to actively control the shape of large space systems. The present technology extends the use of electrostatic soft actuators to bending stiff structures and is able to produce bending deformations in large scale structures. The structure features multiple cells on which conductive electrodes are patterned and may resemble a honeycomb when fully expanded.

Disclosed herein are active structures, and methods for creating active structures, capable of forming large surfaces that can be adjusted in real time. The concept uses thin-shell cell structures in which conductive electrodes are embedded, and the cell expansion can be controlled by applying a voltage between electrodes. When these cells are arranged into bilayer structures, differential cell expansion is used to generate global structural bending. Two electrode configurations were considered: parallel electrodes and zipper electrodes.

A finite element framework for simulation was developed which captures the highly non-linear mechanics of the electrostatic cells. This simulation tool may then be used to conduct parametric studies to assess the actuation capabilities these active structures. The study of a single cell for both simply supported and clamped boundary conditions revealed optimal geometries in terms of maximum expansion and reaction force. Moreover, the study of a bilayer cell system showed that these structures can generate significant rotations and reaction moments. Several electrostatic thin-shell bilayer structures were built using a recently developed silicone molding composite manufacturing process.

Short (130 mm) parallel electrode prototypes were tested and showed that they were able to generate central bending deflections around 200 μm for an applied voltage of about 6 kV. The experimental study also revealed a complex charging behavior (an electrostatic tribolayer effect) which may limit an amount of bending deflection at higher voltages. Moreover, the experiment showed that the chosen cell cross-section was imperfection sensitive, leading to a soft and stiff bending regime.

The soft bending regime was captured accurately by the finite element model but additional work is required to replicate the stiff regime in simulation. Two prototypes featuring zipper electrodes were tested, which have shown superior bending capabilities compared to the parallel electrode structures and are therefore the most promising types of structures for the shape control of large systems. This technology paves the way to the integration of electrostatic thin shell ribs into large planar lattices. The ability of such lattices to morph into 3D shapes has been shown through a finite element simulation, and we presented a pathway to manufacture them using larger molds.

The use of the electrodes as capacitive shape sensors may be an avenue for the design of a fully integrated curvature control solution. On the electrical side, detrimental charging effects can be mitigated by engineering new laminates and provide a pathway to operating these structures at higher voltages. Higher dielectric liquid layers could also be employed to maximize actuation capabilities at low voltages. Finally, bistability in the cell cross-sections can be used to shape lattices into 3D structures without requiring continuous actuation. The electrostatic actuation may be applied for the structure to switch between the undeformed and deformed stable states.

In an embodiment, an electric field is applied between electrodes, causing an electrostatic force to develop. The cell is pinched or similarly deformed along a first axis, which in turn generates linear expansion along a second axis. When these cells are arranged into layers, differential expansion causes bending deformations.

The structures described herein may be assembled into more complex systems such as lightweight planar lattices, which can form large aperture systems capable of adjusting their shape in real time on orbit. These structures can be fully flattened and coiled into a tight volume, enabling lightweight and scalable actuation-deployable space structures.

In some aspects, the techniques described herein relate to an electrostatic structure, the structure including a first flexible structure layer; a second flexible structure layer attached to the first flexible structure layer at a first attachment point and at a second attachment point, the second attachment point being separated from the first attachment point to form a lenticular cell; a first electrode layer attached to the first flexible structure layer; a second electrode layer attached to the second flexible structure layer; and a power supply electrically coupled to the first electrode layer and the second electrode layer and configured to apply a voltage difference between the first electrode layer and the second electrode layer; wherein the first electrode layer and the second electrode layer are configured to alterably define a separation distance between at least a first portion of the first flexible structure layer and a second portion of the second flexible structure layer based on the voltage difference.

In some aspects, the structure may further include an insulating layer attached to at least one of the first flexible structure layer, the second flexible structure layer, the first electrode layer, or the second electrode layer.

In some aspects, each of the first flexible structure layer and the second flexible structure layer includes a fiber-reinforced composite.

In some aspects, the fiber-reinforced composite includes a glass fiber reinforced plastic.

In some aspects, the first flexible structure layer and the second flexible structure layer are attached to each other at a plurality of locations to form a deformable lattice.

In some aspects, the voltage difference is between about 0 V and about 30 kV.

In some aspects, the first flexible structure layer and the second flexible structure layer define a lenticular shape based on the voltage difference.

In some aspects, the first electrode layer is disposed substantially parallel to the second electrode layer.

In some aspects, the first electrode layer extends to a curved portion of the first flexible structure layer and the second electrode layer extends to a curved portion of the second flexible structure layer.

In some aspects, the structure further includes a tessellated repetition of lenticular cells.

In some aspects, the tessellated repetition includes at least two layers of lenticular cells arranged in a bilayer structure.

In some aspects, the techniques described herein relate to a lattice structure, the lattice structure including a plurality of cells, the plurality of cells including two or more flexible structure layers, each flexible structure layer of the two or more flexible structure layers being attached to at least one other flexible structure layer at a first point and at a second point separated from the first point; one or more electrode pairs disposed within one or more of the plurality of cells; and a voltage source communicatively coupled to the one or more electrode pairs and configured to alterably define a shape of the lattice structure based on a voltage difference applied between the one or more electrode pairs.

In some aspects, the plurality of cells are arranged in a bilayer structure.

In some aspects, the one or more electrode pairs are disposed within a first layer of the bilayer structure.

In some aspects, each cell of the plurality of cells is attached to another cell of the plurality of cells.

In some aspects, the cells include lenticular cells.

In some aspects, the cells are arranged in a tessellated pattern.

In some aspects, the techniques described herein relate to a method for shaping a lattice structure, the method including applying, by a voltage source, a first voltage difference between a first electrode pair disposed within a first cell of the lattice structure; applying, by the voltage source, a second voltage difference between a second electrode pair disposed within a second cell of the lattice structure; wherein: the first cell and the second cell are disposed within a first layer of a bilayer structure; and the first voltage difference and the second voltage difference alterably define a length associated with the lattice structure and a height associated with the lattice structure.

In some aspects, the first cell and the second cell include lenticular cells.

In some aspects, the first voltage difference and the second voltage difference are substantially equal.

All combinations of the foregoing concepts and additional concepts discussed in greater detail below (provided such concepts are not mutually inconsistent) are part of the inventive subject matter disclosed herein. In particular, all combinations of claimed subject matter appearing at the end of this disclosure are part of the inventive subject matter disclosed herein. The terminology used herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1 illustrates an exemplary lenticular cell of an electrostatic structure.

FIG. 2A illustrates three layers of lenticular cells arranged together in a tessellated pattern with the top layer of lenticular cells attached directly on top of the bottom layer of lenticular cells.

FIG. 2B depicts lenticular cell including a parallel electrode.

FIG. 2C illustrates a lenticular cell cross section having a zipper electrode.

FIG. 2D illustrates aspects of an exemplary electrostatic structure.

FIG. 3 illustrates an experimental setup to assess the actuation capabilities of bilayer electrostatic thin-shell structures.

FIG. 4A illustrates a displacement of a single lenticular cell in response to a voltage applied between electrodes.

FIG. 4B illustrates a displacement of a bilayer lenticular cell arrangement in response to a voltage applied between electrodes.

FIG. 5A illustrates a clustering of expansion characteristic for a given value of opening angle.

FIG. 5B illustrates a force vs. voltage for various electrostatic cells.

FIG. 6A shows the evolution of the axial cell expansion at pull-in for various electrostatic cells.

FIG. 6B illustrates reaction force characteristics as a function of height, angle, and electrode voltage difference.

FIG. 6C illustrates a deformation of a lenticular cell.

FIG. 6D illustrates a deformation of a lenticular cell.

FIG. 7A illustrates a contour map of the bilayer pull-in rotation and pull-in voltage.

FIG. 7B shows the evolution of the reaction moment and the voltage at pull-in for clamped boundary conditions.

FIG. 7C illustrates an exemplary deformation of a stacked lenticular cell arrangement in the soft regime.

FIG. 7D illustrates an exemplary deformation of a stacked lenticular cell arrangement in the stiff regime.

FIG. 8A illustrates an electrostatic structure having parallel electrodes.

FIG. 8B illustrates an electrostatic structure having zipper electrodes.

FIG. 8C illustrates an electrostatic structure having zipper electrodes.

FIG. 9A illustrates results of a series of experiments.

FIG. 9B illustrates results of a series of experiments.

FIG. 10 illustrates a deflection of a cell when an upper flat region has a slight convex pre-bend.

FIG. 11 illustrates a deflection of a cell when an upper flat region has a slight concave pre-bend.

FIG. 12A illustrates a square lattice arranged in the shape of a spherical cap by selectively applying a voltage difference to individual lenticular cells.

FIG. 12B shows the evolution of the radius of curvature of an electrostatic lattice as a function of applied voltage.

FIG. 13A illustrates a system for manufacturing electrostatic structures.

FIG. 13B illustrates a layup inside of mold prior to mold closure and heating steps.

FIG. 13C illustrates a mold for creating electrostatic thin shell structures and large lattices.

FIG. 14 illustrates a method for shaping a lattice structure.

### DETAILED DESCRIPTION

The present technology is directed to collapsible and deployable structures with utility in space environments such as Earth orbit. In an embodiment, a thin-shell honeycomb-like structure may be formed using thin-ply fiber composites. The honeycomb-like structure includes individual cells. The cell cross-section may follow a lenticular shape, which can be partially or fully collapsed into thin sheets of material.

### Structure

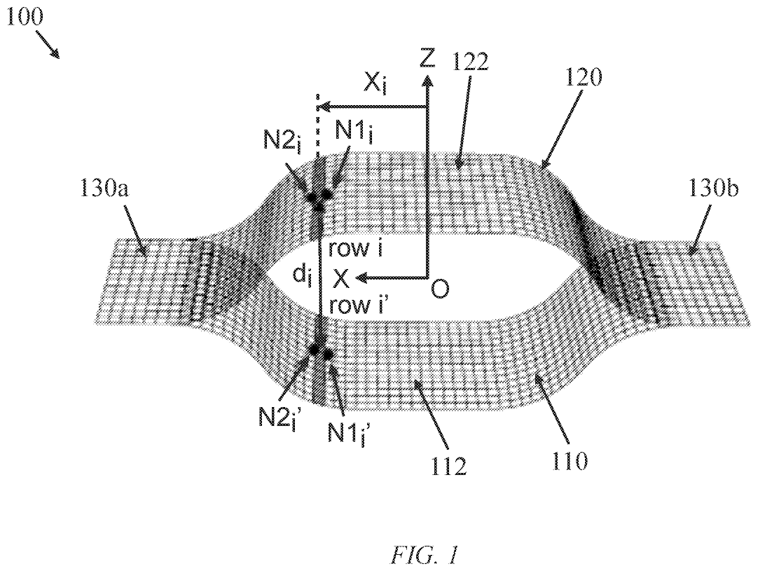

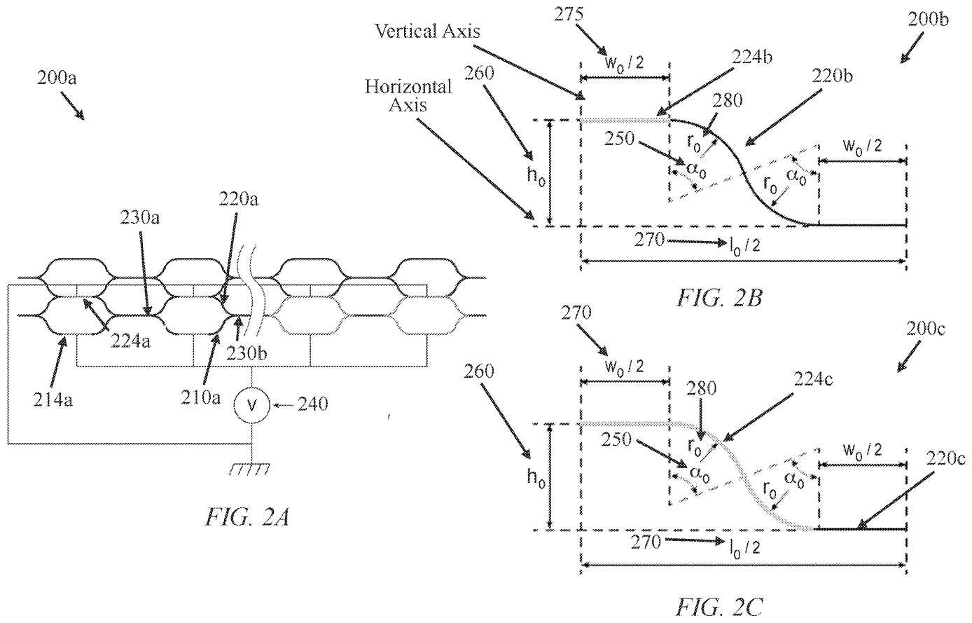

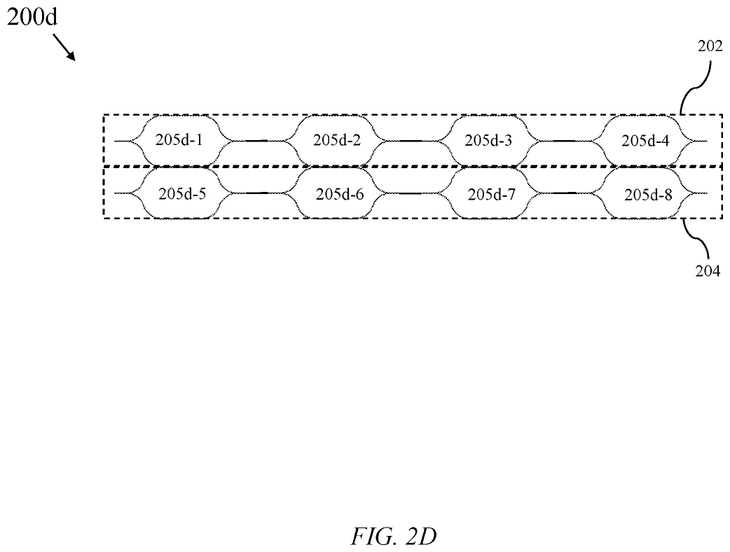

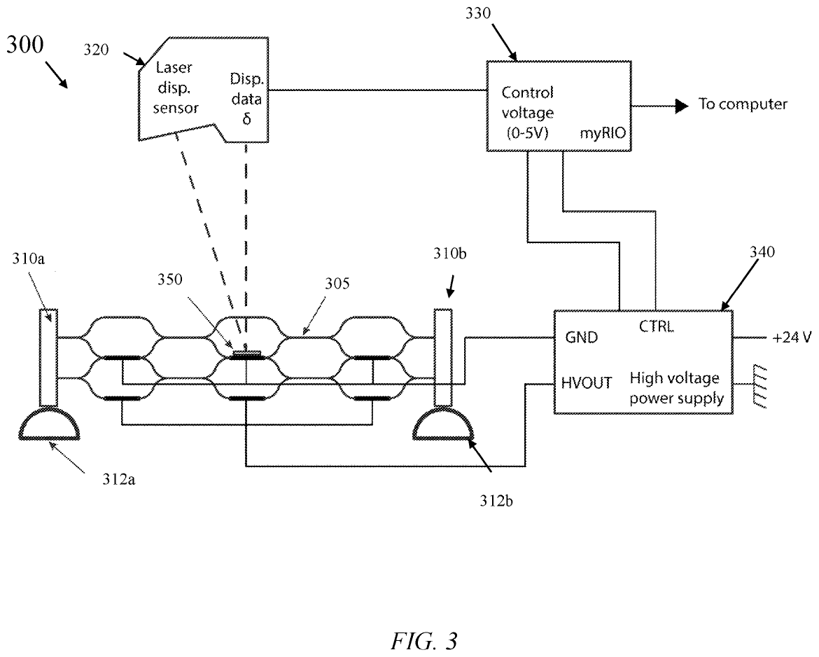

FIG. 1 illustrates an exemplary lenticular cell of an electrostatic structure. The lenticular cell 100 includes a first flexible structure layer 110 and a second flexible structure layer 120. First flexible structure layer 110 may include flat region 112, to which a first electrode (shown in FIGS. 2A-C) may be attached or otherwise affixed. Likewise, second flexible structure layer 120 may include flat region 122, to which a second electrode (shown in FIGS. 2A-C) may be attached or otherwise affixed. First flexible structure layer 110 and second flexible structure layer 120 are attached at first point 130a and at second point 130b. The shape of lenticular cell 100 is such that the lenticular cells may be repeated in a tessellated or nested pattern. FIG. 2A illustrates three layers of lenticular cells arranged together in a tessellated pattern with the top layer of lenticular cells attached directly on top of the bottom layer of lenticular cells. The middle layer of lenticular cells is formed by the curved portions of the top and bottom layers of lenticular cells as well as the attachment points for the flexible structure layers that make up each cell of the top and bottom layer of lenticular cells.

Each cell may include a pair of electrodes or less than each cell may include a pair of electrodes. For example, only a bottom layer of lenticular cells may have pairs of electrodes in each of the lenticular cells of the bottom layer. A bottom layer and a top layer of lenticular cells may each have pairs of electrodes in each lenticular cell of the bottom layer and top layer. In an embodiment, only a top layer and a middle layer of lenticular cells may include lenticular cells with pairs of electrodes. In an embodiment, lenticular cells with pairs of electrodes may be separated from one another; in other words, no lenticular cell having a pair of electrodes may be adjacent to another cell having a pair of electrodes.

FIG. 1 additionally illustrates a parametric finite element framework used to assess the actuation capabilities of a single-cell system, a two-cell system, and/or fully tessellated lattice structure. Finite element modeling may receive cross-section radius and opening angle as inputs, as well as the number of lattice rows, columns, and layers. The structure is represented as a 2-ply laminate. First flexible structure layer 110 and second flexible structure layer 120 are modeled as a 55 μm thick unidirectional glass-fiber reinforced plastic (GFRP, S2/Patz PMT-F7) to which a 57 μm thick polyimide (DuPont Kapton) layer is bonded. An additional layer modeled as 50 μm thick copper foil disposed in flat region 112 and flat region 122 between first flexible structure layer 110 or second flexible structure layer 120 and the polyimide layer.

The cross-section closes in the web regions including attachment point 130a and attachment point 130b, where the top and bottom layer laminates are stacked. The material properties used in the finite element model are summarized in Table 1. The modeled structure is meshed with rectangular reduced integration shell elements (S4R), with an edge seed spacing of 0.7 mm.

TABLE 1
Material properties used in the finite element model.

| | E_1 (GPa) | E_2 (GPa) | G_[12] (GPa) | ν₁₂ | t (μm |
|---|---|---|---|---|---|
| GFRP | 55.0 | 5.5 | 6.4 | 0.26 | 55.2 |
| Copper | 130.0 | — | — | 0.36 | 50.8 |
| Polyimide | 2.8 | — | — | 0.34 | 57.1 |

The electrostatic force is modelled as a set of surface tractions along the y direction. Each electrode is discretized into rows of elements (constant x-coordinate) on which a uniform traction magnitude is defined. For row i with centroid coordinate xᵢ, the traction magnitude is computed as

$$T ( x \text{?} ) = \frac{1}{2} {ϵ}_{0} {{ϵ}_{p} ( \frac{V}{{d}_{i} + 2 \frac{\text{?}}{\text{?}}} )}^{2} \qquad ( 1 )$$

$$\text{?} \text{indicates text missing or illegible when filed}$$

where ϵ₀ is the permittivity of vacuum, ϵᵣ is the relative permittivity of air, ϵₚ is the relative permittivity of polyimide (3.4), tₚ is the thickness of the polyimide layer, V is the applied voltage, and dᵢ is the distance between the centroids of row i and row i′ directly facing on the opposite electrode, see FIG. 1. At each analysis increment, the voltage is increased, and for a given row i, the coordinates of nodes N1i, N2i, N1i′ and N2i′ are extracted using Sensors (from the field output request in Abaqus). These coordinates are then fed to a UAMP Fortran subroutine which computes di and updates the traction magnitude for the given electrode row. The analysis is geometrically non-linear since the traction magnitude depends on the deformed geometry and its direction follows the rotation of the electrode row.

In an embodiment, conductive electrodes attached to the cell top and bottom flanges are connected to a high voltage power supply, and an electrostatic force is created upon voltage application. The cross-section pinching (i.e., height variation), and therefore the cell expansion, can be controlled in real time by varying the applied voltage. Cells are arranged into layers and differential expansion is harnessed to produce large bending deformations. An exemplary structure is illustrated in FIG. 2A and geometric parameters defining the cell cross-sections for a parallel electrode configuration and a zipper electrode configuration are illustrated in FIGS. 2B and 2C respectively. In the parallel electrode scheme, shown in FIG. 2B in light grey, parallel electrodes span the flat top and bottom sections of the cell, whereas zipper electrodes shown in FIG. 2C in light grey are spanning the entire cell cross-section until just before the points where the two structure layers meet.

FIG. 2A illustrates a structure arrangement 200a in accordance with the present technology. Structure arrangement 200a includes a plurality of flexible structure layers forming a plurality of lenticular cells including first flexible structure layer 210a and second flexible structure layer 220a. First flexible structure layer 210a and second flexible structure layer 220a may include or be made of a composite material such as a matrix material and reinforcing fiber. For example, first flexible structure layer 210a and second flexible structure layer 220a may be made of a glass-fiber reinforced plastic (GFRP). The reinforcing fiber may include glass fiber, carbon fiber, plant-based fibers such as hemp, or any suitable reinforcing fiber. The reinforcing fiber may be arranged unidirectionally (e.g., having bundles of reinforcing fibers aligned in substantially the same direction), bidirectionally (e.g., having bundles of reinforcing fibers aligned in substantially two directions having an approximate predetermined angle between the two directions), or multidirectionally (e.g., having bundles of reinforcing fibers arranged in multiple different directions).

The plurality of lenticular cells may be arranged in a tessellated pattern. First flexible structure layer 210a and second flexible structure layer 220a are attached to one another in at least two points, first attachment point 230a and second attachment point 230b. First flexible structure layer 210a and second flexible structure layer 220a may be attached at first attachment point 230a and second attachment point 230b using a mechanical attachment mechanism such as a fastener, clamp, screw, bolt, tie, wire, etc., may be attached using an adhesive, may be attached using a matrix material from a fiber-reinforced composite such as a thermoset, thermopolymer, epoxy, or other suitable matrix material, or using any suitable attachment mechanism.

FIG. 2A further illustrates a voltage source 240 configured to apply a voltage between two or more electrodes such as electrode 214a and electrode 224a. Voltage source 240 may be configured to apply a voltage difference of between about 0 V and about 30 kV. Voltage source 240 may apply between about 5 kV and about 10 kV, between about 3 kV and about 8 kV, between about 8 kV and about 20 kV, between about 4 kV and about 20 kV, between about 10 kV and about 30 kV, greater than about 10 V, greater than about 50 V, greater than about 100 V, greater than about 600 V, greater than about 1 kV, greater than about 2 kV, greater than about 5 kV, greater than about 10 kV, greater than about 20 kV, greater than about 30 kV, or any suitable voltage difference.

FIGS. 2B and 2C illustrate dimensions of portions of exemplary lenticular cells 200b and 200c in accordance with the present technology. FIG. 2B depicts lenticular cell 200b including a parallel electrode 224b. Parallel electrode 224b is disposed on a flat portion of structure layer 220b opposite an analogous electrode disposed on the opposing structure layer defining lenticular cell 200b. When fully deployed, a lenticular cell may have initial curve angle 250 α₀, initial height 260 h₀, initial length 270 l₀, electrode region length 275 w₀ (which may be equal to attachment region length), and initial curve radius 280 r₀. Each of curve angle 250, initial height 260, initial length 270, electrode region length 275, and initial curve radius 280 may be altered or selected to modify or improve performance of an electrostatic structure such as structure arrangement 200a.

FIG. 2C illustrates a lenticular cell 200c cross section analogous to that of 200b, except having a zipper electrode 224c. Zipper electrode 224c extends beyond the flat upper or lower region of a lenticular cell into the curved portions. Zipper electrode 224c also extends almost fully into the attachment region between top and bottom layers of the lenticular cell. Zipper electrode 224c may advantageously enable greater vertical deflection and therefore greater horizontal expansion of a lenticular cell for a given voltage difference between opposing electrodes.

When the structure is pulled or stretched lengthwise such that a cell's length increases to l>l₀, its height may decrease to h<h₀ to conserve the length of layers 220b and/or 220c. This expansion mechanism may be controlled using electrostatic actuation. Curved flanges of lenticular cells 200b and 200c may have opening radius r and opening angle a. Opening radius r may increase with decreasing voltage difference between two opposing electrodes of a lenticular cell, in other words as the two structure layers of a lenticular cell are pulled together. Similarly, opening angle a may decrease with decreasing voltage difference between two opposing electrodes of a lenticular cell, in other words as the two structure layers of a lenticular cell are pulled together.

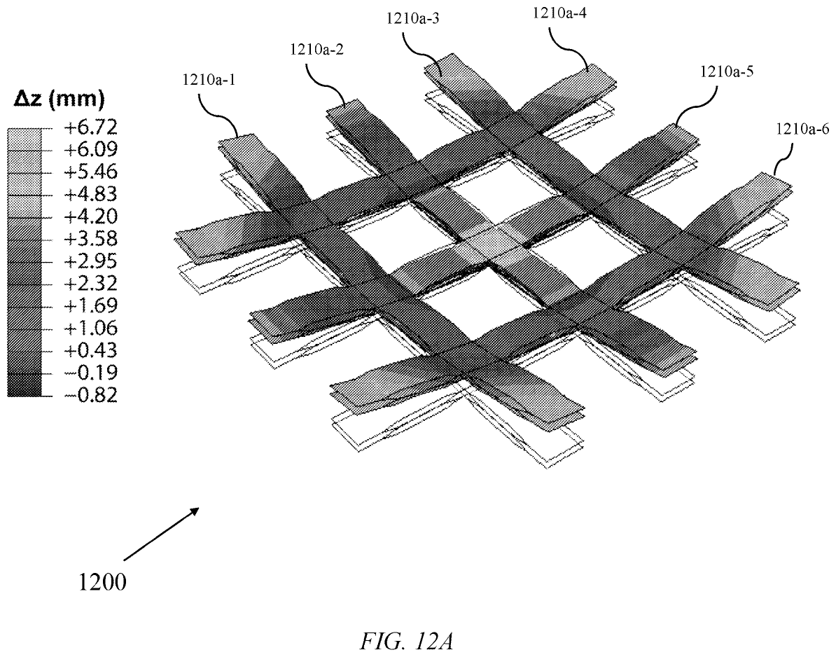

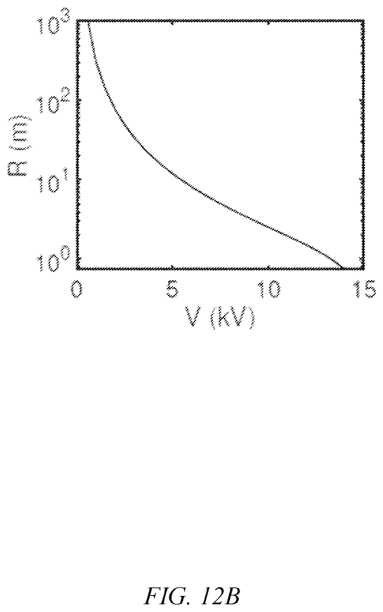

FIG. 2D illustrates aspects of an exemplary electrostatic structure 200d. Electrostatic structure 200d may include lenticular cells 205d-1 through 205d-8 organized in a bilayer structure that includes an upper layer 202 of electrostatic structures and a lower layer 204 of electrostatic structures. Upper layer 202 may include lenticular cells 205d-1 through 205d-4 and lower layer 204 may include lenticular cells 205d-5 through 205d-8. Electrostatic structure 200d may include more than two layers, for example, three layers, four layers, or any suitable number of layers. Any, some, or all of lenticular cells 205d-1 through 205d-8 may include one or more pairs of electrodes configured to define a cell height of 2*h₀ based on a voltage difference applied between the electrode pair(s). Electrostatic structure 200d may additionally or alternatively be referred to as a “rib.” A first plurality of electrostatic ribs may be arranged perpendicularly to a second plurality of electrostatic ribs to form an electrostatic lattice, such as electrostatic lattice 1200 illustrated in FIG. 12A.

### Testing

FIG. 3 illustrates an experimental setup 300 to assess the actuation capabilities of bilayer electrostatic thin-shell structures. The extremities of electrostatic structure 305 may be glued into end caps 310a and 310b, which provide a stiff coupling between top and bottom layers. These end caps 310a and 310b may be attached to cylindrical low friction supports 312a and 312b, which approximate simply supported boundary conditions. A laser target 350 may be attached on the top electrode of the central bilayer and serves as a target for a laser displacement sensor 320 to track the central deflection of the neutral axis (e.g., orthogonal to flat region 112 and/or flat region 122 in lenticular cell 100 of FIG. 1). A field-programmable gate array (FPGA 330) or similar processor may control a high voltage power supply 340 configured to deliver a voltage or range of voltages between electrodes. In an embodiment, FPGA 330 may include one or more processors such as one or more central processing units (CPUs), graphics processing units (GPUs), FPGAs, ASICs, or any suitable processor. The actual applied voltage and displacement data may be measured by the laser displacement sensor and communicated to FPGA 330 and tracked in real time through a custom Labview™ program.

High voltage power supply 340 applies a voltage between approximately 1 kV and 30 kV, such as 12 kV, and a displacement of laser target 350 is measured in order to characterize the response of structure 305 to the applied voltage. In an embodiment, electrostatic structure 305 may include six lenticular cells arranged in a top row and a bottom row. The bottom flat regions of the top row of lenticular cells may be attached to the top flat regions of the bottom row of lenticular cells. In an embodiment, only the lenticular cells of the bottom row include pairs of electrodes.

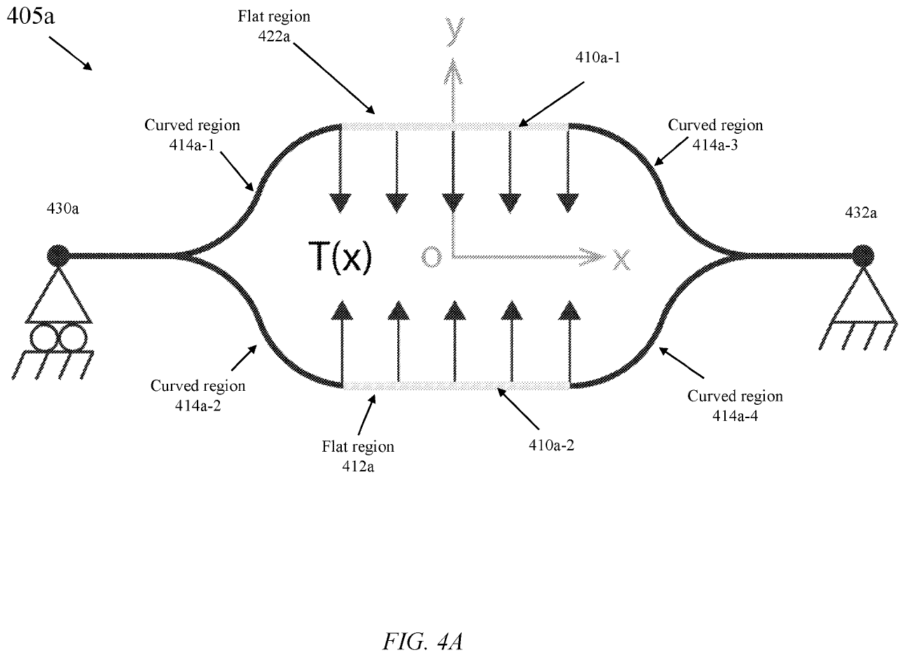

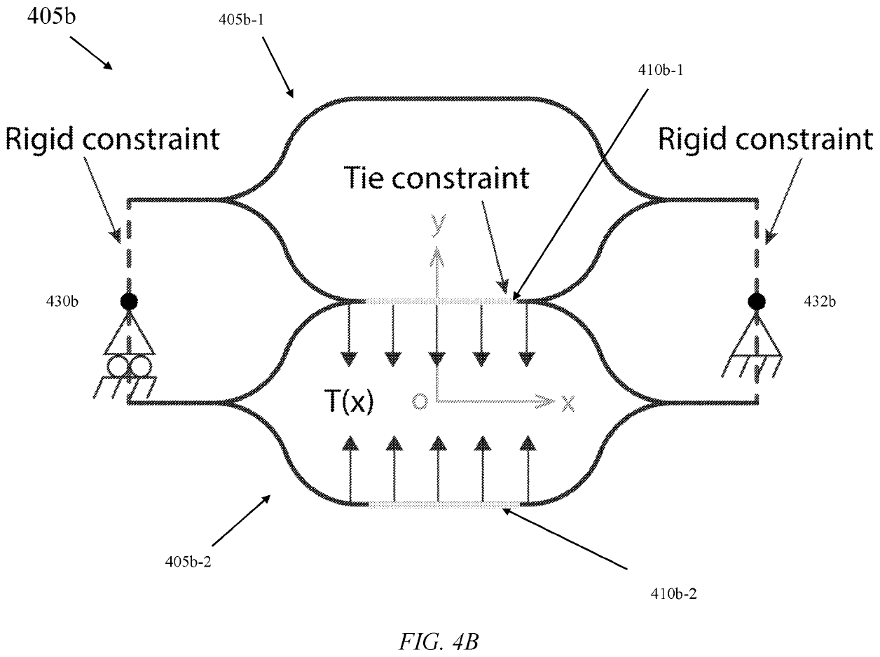

FIGS. 4A and 4B illustrate deflection regimes based on forces that exemplary lenticular cells 405 experience during design loading. Two types of structure deflection regimes are observed: expansion and bending. The experimental setup utilized a parallel electrode configuration such as 200b illustrated in FIG. 2B. The expansion analysis, illustrated in FIG. 4A, utilizes a single lenticular cell 405a.

A voltage difference is applied between top electrode 410a-1 and bottom electrode 410a-2, and the two sides edges are rigidly coupled to two reference points, on which boundary conditions are applied. To assess the maximum axial linear expansion, and maximum axial force the lenticular cell 405 can generate, we consider two types of boundary conditions. The first boundary condition scheme (simply supported, Uₓ free) has reference point 432a fully clamped while reference point 430a is only allowed to translate in the x direction. The displacement of 430a in the x direction is used to compute the cell expansion. In the second boundary condition scheme (clamped, Uₓ=0), 430a is fully clamped and the reaction force in the x direction is extracted.

FIG. 4A illustrates a scenario in which a single row of lenticular cells 405 (each analogous to 405a), each connected at attachment points 430a and 432a or analogous attachment points, are displaced in the x direction in response to displacement of the top and bottom surface of the lenticular cells 405 to which first electrode 410a-1 and second electrode 410a-2 (and analogous electrodes for additional lenticular cells 405) are attached. First electrode 410a-1 may be disposed partially or entirely on flat region 422a of lenticular cell 405a. Second electrode 410a-2 may be disposed partially or entirely on flat region 412a. The expansion of lenticular cell 405a may additionally be a function of stiffness of curved regions 414a-1, 414a-2, 414a-3, and 414a-4. In an embodiment, curved regions 414a-1 to 414a-4 may define curved regions of tessellated lenticular cells nested with lenticular cell 405a or an analogous lenticular cell.

For each lenticular cell 405, a displacement in the x direction may be proportional to a displacement in the y direction caused by the voltage difference between the first electrode and the second electrode. The displacement in the x direction for the overall structure will be linearly proportional to the number of lenticular cells in the structure. For example, if a voltage differential of 10 kV between top and bottom electrodes for a lenticular cell causes a displacement in the x direction of 0.38% of the initial lenticular cell length l₀, and l₀ is 130 mm, then five substantially identical lenticular cells connected to one another at points analogous to 430a and 432a will experience a displacement between extreme ends of 24.7 mm.

FIG. 4B illustrates a scenario where two lenticular cells 405b-1 and 405b-2 are constrained at a surface (the bottom surface of lenticular cell 405b-1 and the top surface of lenticular cell 405b-2) and a voltage is applied between first electrode 410b-1 and second electrode 410b-2. Lenticular cells 405b-1 and 405b-2 may be substantially identical to lenticular cell 405a. In an embodiment, lenticular cell 405b-1 may not include an electrode. The side edges of both top and bottom lenticular cells 405b-1 and 405b-2 are rigidly coupled to two reference points 430b and 432b, on which boundary conditions are applied. Two boundary condition schemes are considered. In both boundary condition schemes, the two reference points are allowed to rotate around the z-axis (orthogonal to the drawing page), while 430b is free to translate along the x-direction. In the first boundary condition scheme, 432b and 430b are left on of 430b around the z axis is extracted. In the second boundary condition scheme, both reference points are clamped and the reaction moment at 430b is determined.

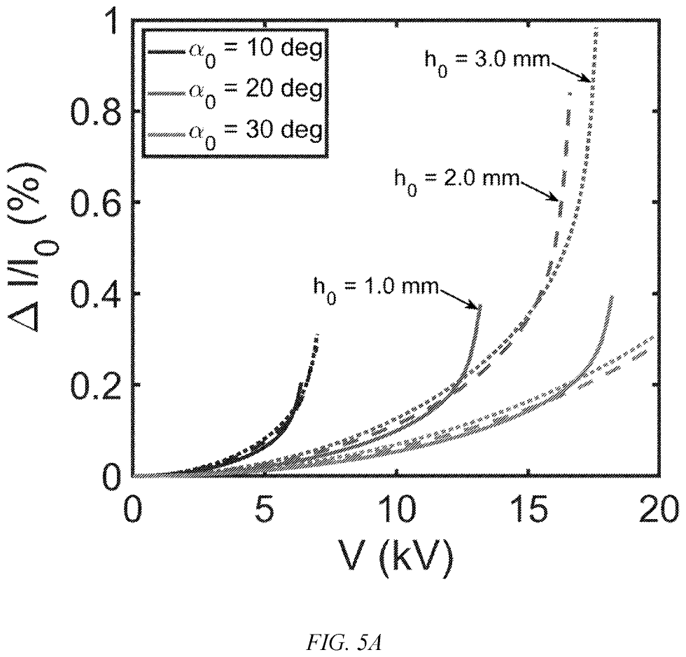

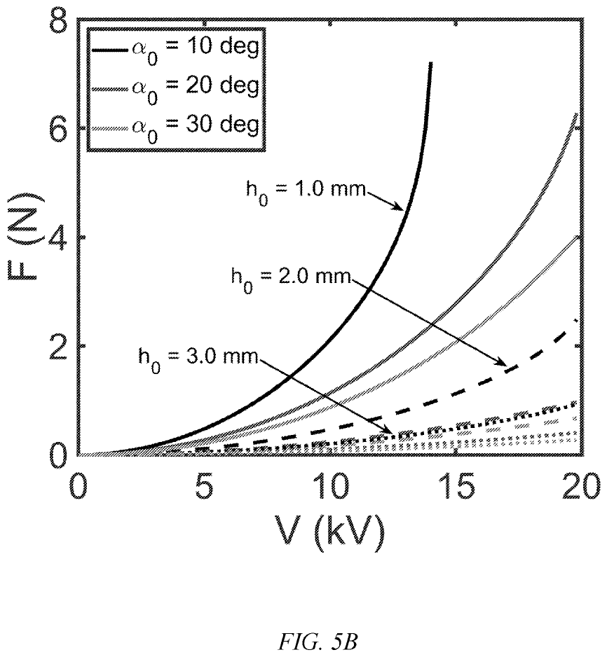

For lenticular cells illustrated in FIG. 4A-B and characterized in FIGS. 5A-B, 6A-D, and 7A-D, the cell depth (z-direction) may be chosen as b=25 mm and the flat electrode section length may be chosen as wₑ=13 mm. The cross-section opening angle α₀ is varied between 5 deg and 30 deg, and the cross-section height h₀ may be between 0.5 mm and 3.25 mm.

The electrostatic structures 405a as well as 405b-1 and 405b-2 are highly nonlinear. The electrostatic force increases quadratically as the shell deforms and the gap between electrode narrows. Since the structural stiffness in the y direction is approximately linear, the cross-section vertical displacement increases quadratically when the voltage increases linearly. At a critical voltage, the system destabilizes, and the displacement vs voltage curve exhibits a vertical tangent. At this point, the structure undergoes a snap-through referred to as pull-in instability, and the two electrodes come into contact. The instability occurs when the voltage reaches the pull-in voltage Vₚ.

FIG. 5A illustrates a clustering of expansion characteristic for a given value of opening angle. For α₀=30° and h₀=2.0 mm and h₀=3.0 mm, the expansion characteristics reach the maximum voltage before pull-in occurs, and expansion is limited by the system's electrical capabilities rather than by instabilities. In other words, the cell cannot reach pull-in instability at α₀=30° and h₀≥2.0 mm given a maximum applied voltage of 20 kV and the given materials. FIG. 5A shows expansion vs voltage characteristics as a function of the cross-section height and opening angle for lenticular cell 405a. The end point of the characteristic is used as an approximation of the pull-in point. In reality, pull-in occurs when the tangent to the curve is strictly vertical, and therefore at slightly higher voltages.

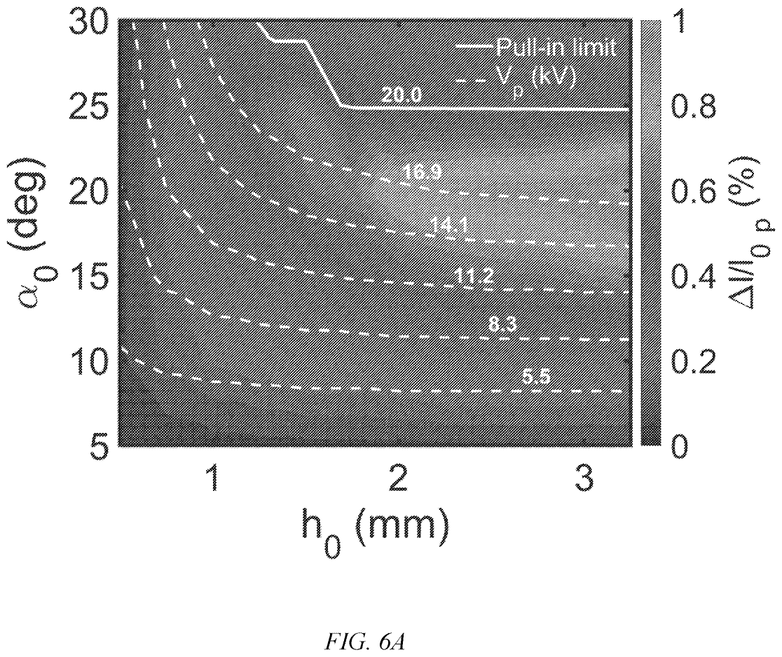

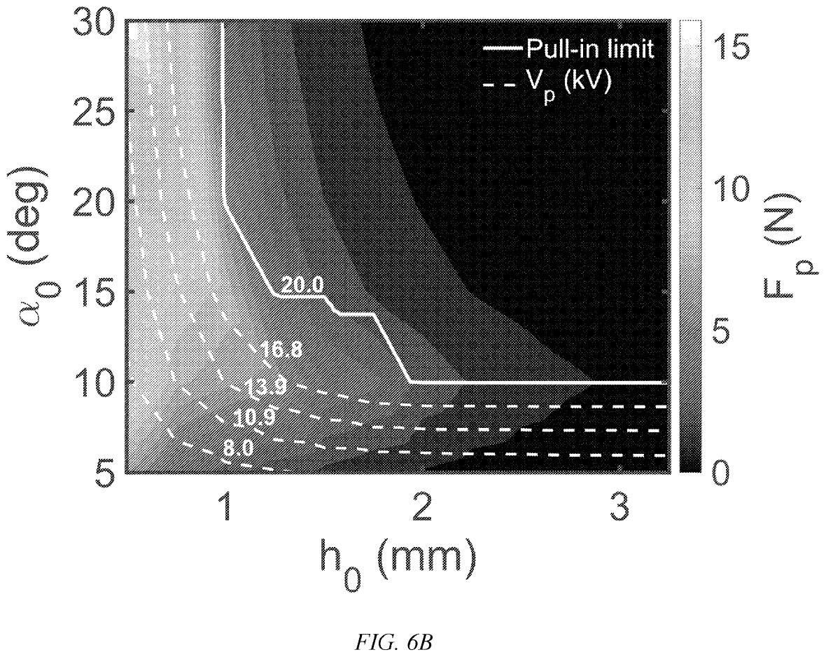

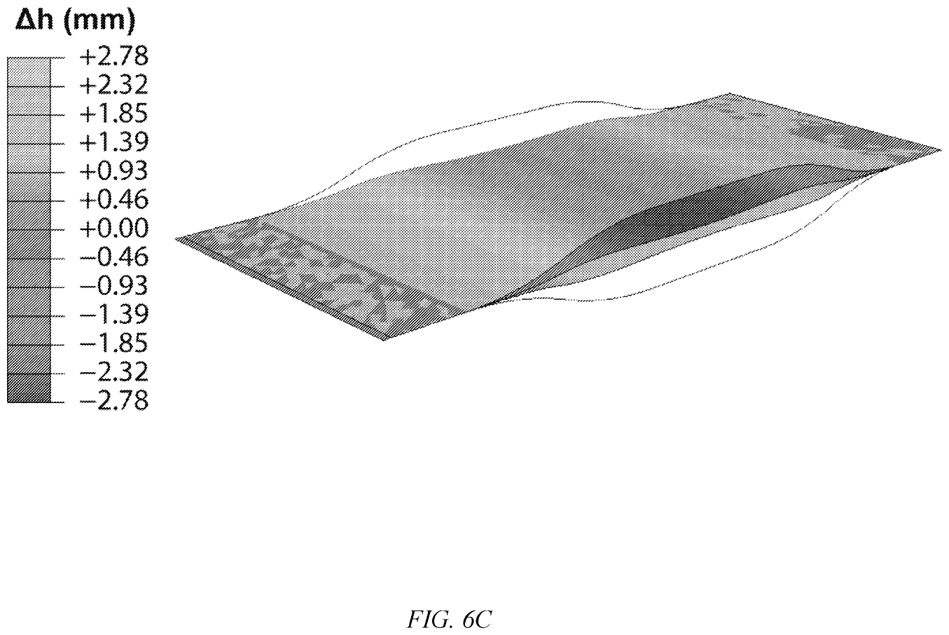

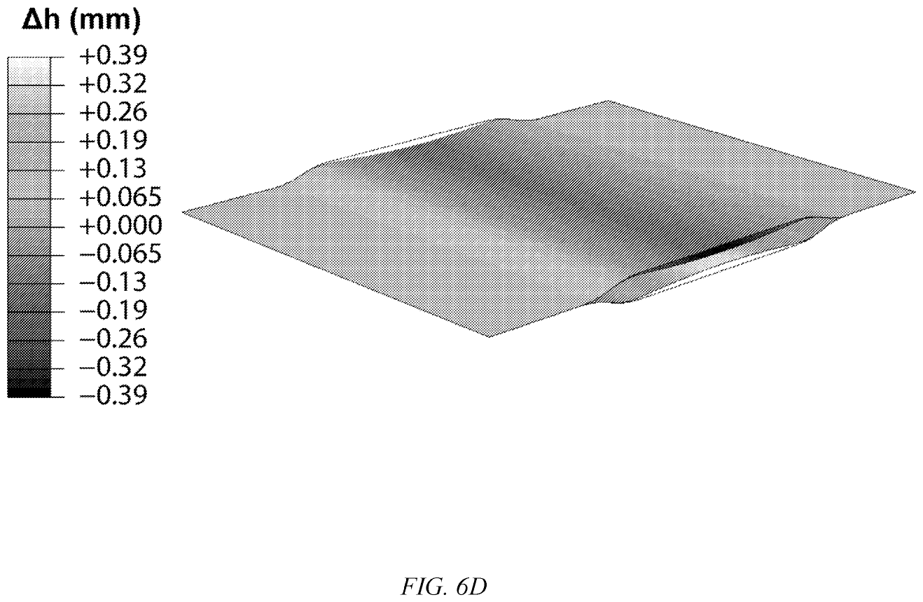

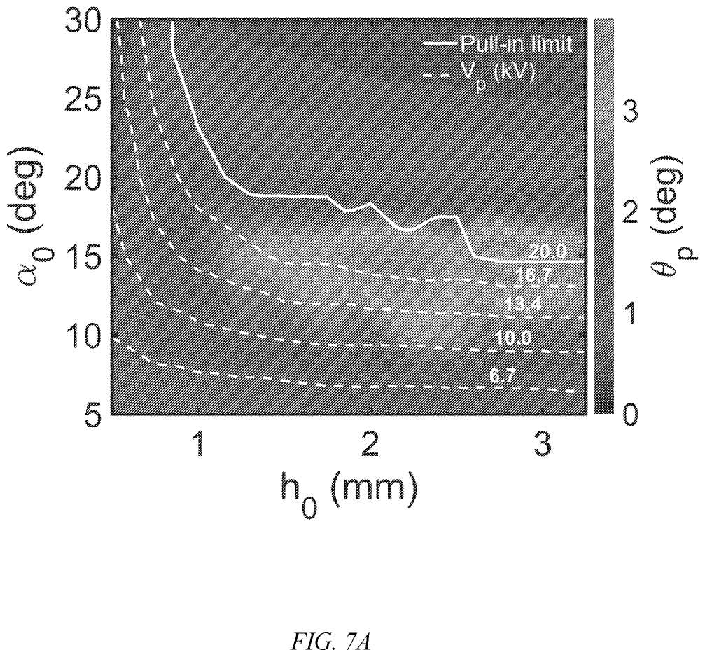

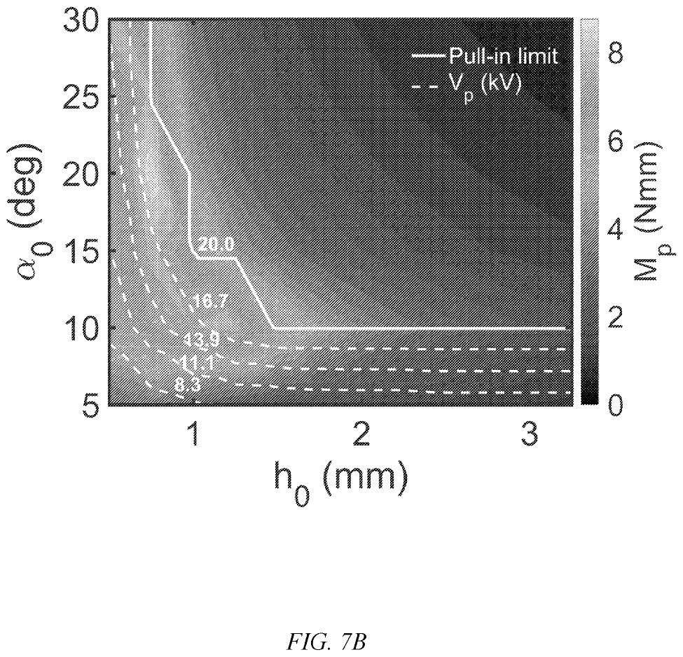

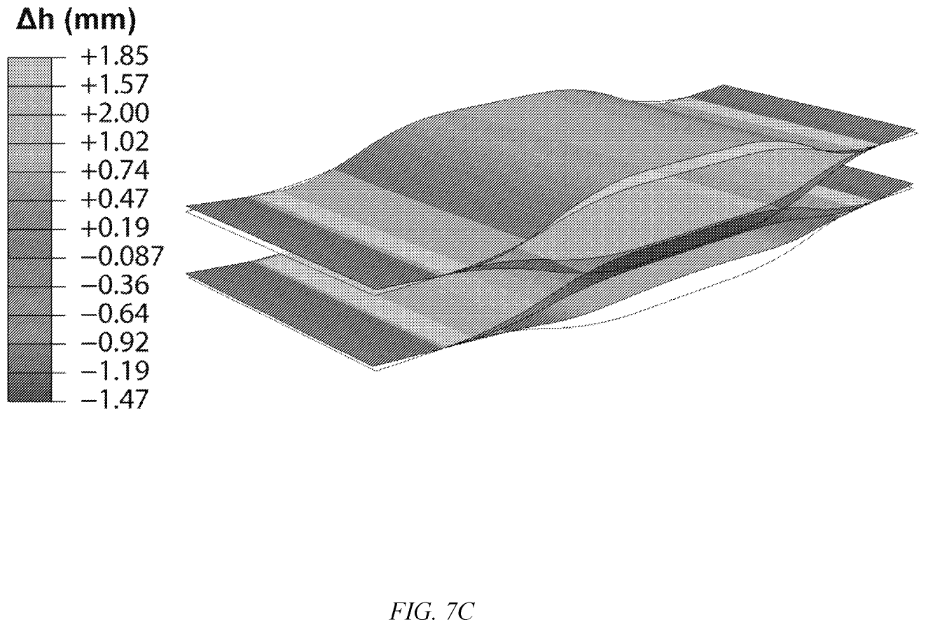

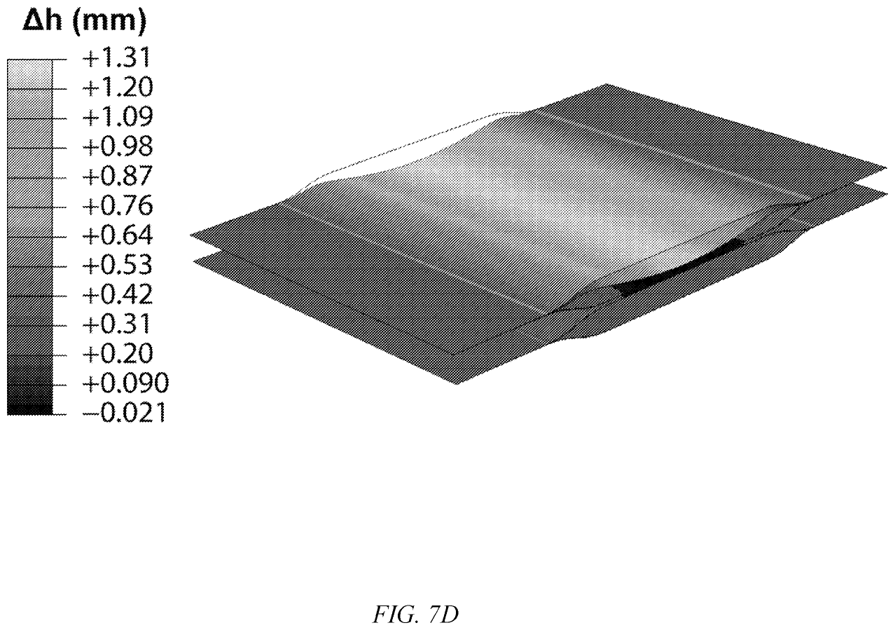

FIGS. 6A-D illustrate operational behavior of lenticular cell 405a of FIG. 4A. FIGS. 7A-D illustrate operational behavior of lenticular cells 405b-1 and 405b-2 of FIG. 4B.

FIG. 6A shows the evolution of the axial cell expansion at pull-in, for the simply supported boundary conditions. In addition, contours of equal pull-in voltage are overlaid in white dashed lines. The maximum pull-in voltage is achieved for higher values of height and opening angle, which correspond to stiffer cross-sections in the y direction (flattening stiffness). Above the solid white line in FIG. 6A, the maximum voltage is reached before pull-in occurs. The highest values of expansion are achieved for α₀=20 deg and monotonically increase with the cross-section height. For α₀=20 deg and h₀=3.25 mm, the maximum value of expansion is achieved and is around 1%. For larger values of opening angles, the ratio between the flange arclength and the initial cell length increases, potentially providing more actuation capabilities. However, the distance between electrodes increases and the electric field strength is weaker for the same applied voltage.

Each dotted line shows a constant voltage curve for select voltage values between 5.5 kV and 20 kV, specifically 5.5 kV, 8.3 kV, 11.2 kV, 14.1 kV, 16.9 kV, and 20 kV. FIG. 6A further illustrates that a smaller initial height h₀ decreases both a maximum expansion of a lenticular cell in the x direction as well as the voltage required to reach pull in instability.

FIG. 6B illustrates reaction force characteristics as a function of initial height h₀, initial angle α₀, and electrode voltage difference of about 8 kV to about 20 kV. FIG. 5B shows no clustering of curves based on the opening angle; rather, the curves are ordered by cross-section height. Operating the lenticular cells beyond pull-in may be utilized to achieve large deformations, and as a locking mechanism to achieve high load bearing capabilities on demand. From a practical consideration, the voltage may be limited by the dielectric breakdown of the air between electrodes, and a high dielectric constant may be added to the electrode surface to minimize the risk of arcing. FIG. 6B illustrates a general trend of increasing force with decreasing separation (height), which accords with attraction between two parallel plates based on an applied voltage bias.

FIG. 6B shows the evolution of the axial reaction force and voltage at pull-in, for the clamped boundary conditions. For a given h₀ and α₀, the pull-in voltage more than doubles when the simply supported boundary conditions are replaced by the clamped boundary conditions, due to the increase in flattening stiffness for all geometries. The reaction force increases as the cross-section height decreases, since the reduction in initial distance between the electrodes causes a quadratic increase in electric field. At very low h₀, the reaction force is highest for larger α₀. This range of geometric parameters corresponds to higher values of bending stiffness for the curved flanges, and the electrostatic force is transferred to the cell edges with minimal deformations of these flanges. The maximum value of reaction force is reached for h₀=0.5 mm and α₀=30 deg, and is around 15 N. However, when h₀ increases, the region of highest reaction force shifts to lower values of opening angles. Note that the region for which the maximum voltage is reached before pull-in is greatly extended for this boundary condition scheme.

FIG. 6C illustrates a deformation of lenticular cell 405a with an α₀=30° and h₀=3.25 mm at 16.9 kV. The center of flat regions 412a and 422a undergo the greatest deformation of +2.78 mm with deformation decreasing non-linearly in curved regions of lenticular cell 405a. In an embodiment, an initial height h₀ and initial curve angle α₀ may be selected to provide a desired Δl/l₀ or ratio of change in length to initial length of an exemplary lenticular cell for a given voltage.

The undeformed and deformed cell shapes for h₀=3.25 mm and α₀=20 deg are shown in FIG. 6C, with a greyscale map of the vertical cross-section displacement. At pull-in and for this specific geometry, the cross-section height decreases by 85%. The deformed shape may include both flattening of the curved flanges and bending of the electrodes. While the curve flange flattening may provide positive expansion, the bending of the electrodes may reduce the cell actuation capabilities. In an embodiment, the actuation efficiency of parallel electrode cells may be further improved by increasing the local bending stiffness in the electrode region relative to the curved regions 414a-1 through 414a-4 or regions including attachment points 430a and 432a.

FIG. 6D illustrates a deformation of lenticular cell 405a with α₀=20° and h₀=0.75 mm at 13.9 kV. The center of flat regions 412a and 422a undergo the greatest deformation of +2.78 mm with deformation decreasing non-linearly in curved regions of lenticular cell 405a. At pull-in and for this specific geometry, the cross-section height decreases by 52%. Like in the free expansion case, the deformed shape features both flattening of the curved flanges and bending of the electrodes.

FIGS. 7A-D illustrate behavior of a stacked lenticular cell arrangement such as lenticular cells 405b-1 and 405b-2 depicted in FIG. 4B, in which only bottom lenticular cell 405b-2 includes electrodes and is electrostatically actuated.

FIG. 7A illustrates a contour map of the bilayer pull-in rotation and pull-in voltage. FIG. 7A illustrates an increased value of pull in voltage for a given deflection. In an embodiment, an electrostatic structure including two or more stacked lenticular cells may have lower values of opening angles without pull in as compared to a single lenticular cell at the same voltage and opening heights. The flat region to which electrode layer 410b-1 is attached (corresponding to flat region 122 in FIG. 1) includes two flexible structure layers attached to one another, increasing the thickness and therefore overall stiffness of the flat region. Similarly, the region of high bending rotation is found at lower values of opening angles and the rotation magnitude may be maximized for α₀=15 deg.

The two local minima of bending rotations are found for h₀=2.25 mm and h₀=2.75 mm, with a rotation magnitude close to 4 deg. Even if increasing h₀ leads to higher values of bottom cell expansion, and therefore larger differential expansion between the two layers, it also increases the overall height of the structure which increases its bending stiffness. The competition between these two effects explains that rotation maxima are not found for h₀>2.75 mm.

The undeformed and deformed bilayer shapes for h₀=2.75 mm and α₀=15 deg is shown in FIG. 7C, with a greyscale map of the vertical cross-section displacement. The bottom lenticular cell 405b-2 height reduces and the cell expends when the voltage is applied, but local bending deformations localize on the bottom electrode, since the top electrode thickness is doubled compared to the single lenticular cell configuration 405a. The flattening and axial expansion of actuated lenticular cell 405b-2 causes the height of the top cell 405b-1 to increase, and the lenticular cell 405b-2 to contract along the x-axis. The difference in axial expansion between the two cells causes bending such that the bilayer neutral axis shifts upward during the deformation process.

FIG. 7B shows the evolution of the reaction moment and the voltage at pull-in, for the clamped boundary conditions. Similar to the simply-supported boundary conditions analysis, the pull-in voltage increases overall and the high values of reaction moment are shifted to lower opening angles. A maximum reaction moment of 8.9 Nm is found for h₀=0.75 mm and α₀=20 deg. The deformed shape for this specific geometry is shown in FIG. 7D and highlights the localization of deformation (local bending) on the bottom electrode of the actuated cell. The bilayer is shown upside-down in FIG. 7D for ease of visualization.

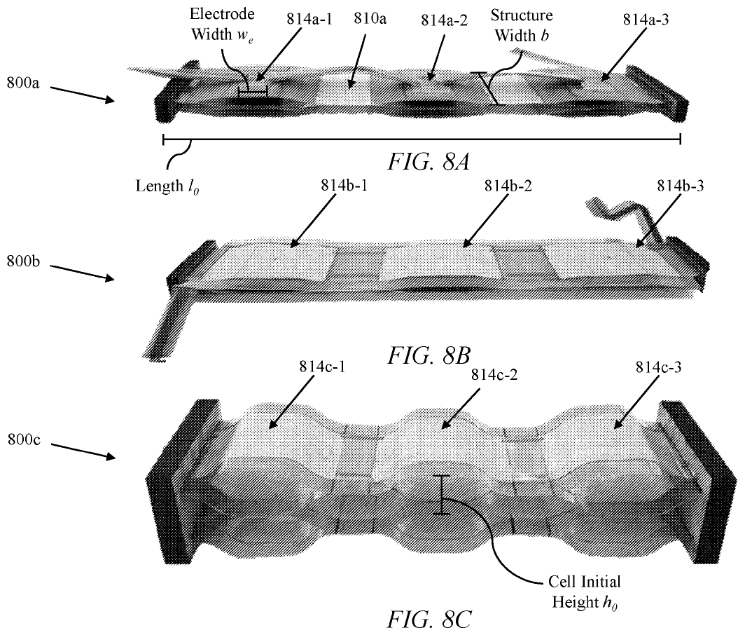

FIGS. 8A-8C illustrate exemplary electrostatic structures 800a-c in accordance with the present technology. FIG. 8A shows electrostatic structure 800a having six lenticular cells 805a-1 through 805a-6 in an arrangement analogous to that of electrostatic structure 305 in FIG. 3. Electrostatic structure 800a is shown with a parallel electrode arrangement including parallel electrodes 814a-1 through 814a-3. The bottom electrodes opposite 814a-1 through 814a-3 are not visible in FIG. 8A. Electrostatic structure 800a is shown with an initial curve radius of 15 mm and an initial curve angle of 16°. For each lenticular cell of electrostatic structure 800a, the flat electrode length may be wₑ=13 mm. The width of each of electrostatic structures 800a-c may be b=25 mm and the length of each of electrostatic structures 800a-c may be l₀=130 mm. Each lenticular cell of electrostatic structure 800a may have an opening height of 2.3 mm.

The flexible structure layer employed in electrostatic structures 800a-c may be analogous to or the same as that described with respect to FIG. 1. In an embodiment, the insulating polyimide layer (cell innermost ply) may not extend to the web region 810a (in which the two GFRP plies meet). An additional layer of polyimide tape is added to the flat electrode region and wraps around the entire structure providing a full encapsulation against arcing. Finally, flexible conductive tape stripes wrapped in polyimide may connect the cells in series through a hole in the glass fiber and polyimide plies.

FIG. 8B illustrates electrostatic structure 800b including zipper electrodes 814b-1, 814b-2, and 814b-3. Electrostatic structure 800b is shown with an initial curve radius of 15 mm and an initial curve angle of 16°. Each lenticular cell of electrostatic structure 800b may have an opening height of 2.3 mm.

FIG. 8C illustrates electrostatic structure 800b including zipper electrodes 814b-1, 814b-2, and 814b-3. Electrostatic structure 800b is shown with an initial curve radius of 7 mm and an initial curve angle of 60°. Each lenticular cell of electrostatic structure 800c may have an opening height of 14 mm.

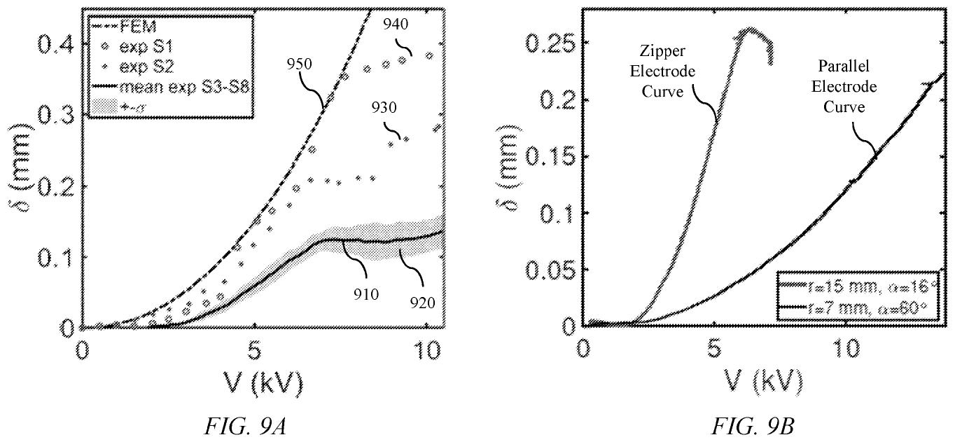

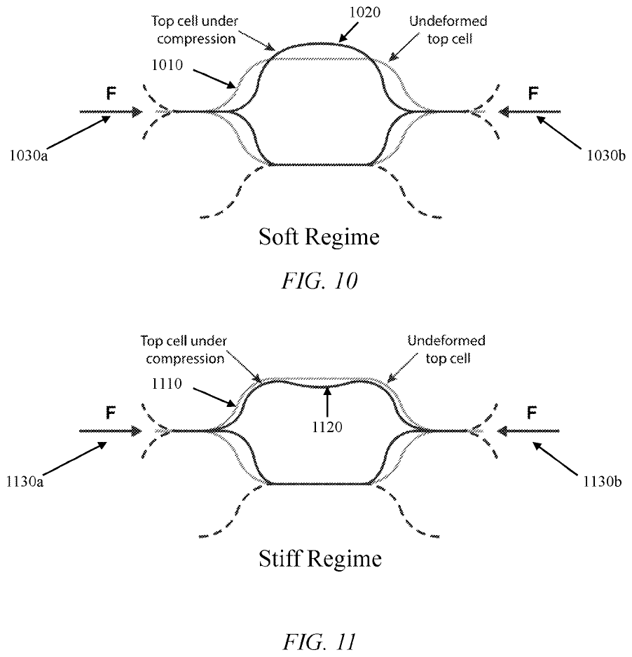

FIG. 9A illustrates a series of eight experiments on electrostatic structures including electrostatic structures 800a-c in which voltage between electrodes is ramped from 0 to 15 kV at a rate of 1.5 kV/s and the central rib deflection is measured. The results of these eight experiments are shown in FIG. 9A. Over the whole range of experiments, six structures (labeled S3 to S8) exhibit a similar behavior. For this subset of experiments, we compute the average deflection and standard deviation, illustrated as black line 910 and grey surrounding cloud 920 respectively in FIG. 9A. This behavior of a quadratic ramp of deflection with voltage followed by an approximate leveling off of deflection with voltage is hereinafter referred to as “stiff regime” bending (illustrated in FIG. 11). In addition, two structures (S1 and S2) display a significantly different behavior, shown with crosses 930 and circles 940 in FIG. 9A. This behavior of a quadratic ramp to a higher deflection for a given voltage as compared to S3-S8 is hereinafter referred to “soft regime” bending (illustrated in FIG. 10). A finite element analytical framework is used to simulate the experiment and is shown as dashed line 950 in FIG. 9A.

For all 8 structures represented by 910, 930, and 940, the deflection vs voltage curve is initially quadratic which agrees with the inverse proportionality between the electrostatic force and the square of the gap distance between electrodes. However, at a critical voltage between 6.5 and 7.5 kV, the quadratic growth in deflection is abruptly interrupted, and the response for a higher range of voltages plateaus or increases very slowly. This type of behavior was observed in other electrostatic actuators and is most likely caused by undesired charging issues.

At higher voltages, the electric field is large enough to ionize the air in the cells, and charges deposit on the surface of the polyimide layer through corona discharge. The resulting surface charging effect is referred to as an electrostatic tribolayer. The charges that deposit on one electrode insulation layer have an opposite polarity to that of the electrode, effectively reducing the electric field in the cavity.

The second main observation is the significant difference in behavior between the stiff and soft regimes, even if the 8 structures display nominally analogous behavior. The finite element simulation approximates the soft regime well until the appearance of the electrostatic tribolayer. A potential explanation for this difference in behavior is the presence of geometric imperfections in the top layer cross-section; in particular, initial curvature on the upper flat sections of the top cells.

When an electrostatic structure such as 800a-c undergoes bending, the top layer and therefore the top flat sections, undergo compression. Under this in-plane compressive loading, these nominally planar shells buckle, and post-buckling bending deflection can develop in two possible directions, upward or downward. As such these flat sections are in a bistable state. In practice, initial curvature in the nominally flat sections (e.g., regions 412a and 422a of lenticular cell 405a) bias the structures towards following a specific direction of post-buckling deflections. In the case of an initial downward curvature imperfection, compression on the top cells results in downward bending of the flat sections, and the height of the cell decreases. Such an initial downward curvature imperfection creates a region of high localized curvature at the center of the flat sections (opposite the directions to the curvature in the circular flanges, e.g., curved regions 414a-1 through 414a-4). This mode of deformation leads to a stiffer structure.

In the case of an initial upward curvature imperfection, compression results in upward bending of the flat sections, and the height of the top cell increases. The curvature at the center of the flat section is moderate and in the same direction as the curvature in the circular flanges. This mode of deformation leads to a softer structure. The different deformation mechanisms in the soft and stiff regimes are illustrated in FIG. 10 and FIG. 11. When looking closely at manufactured electrostatic structures, we notice that most of them exhibit a small downward initial curvature imperfection on the top layer cells. In addition, a sudden increase in deflection is observed for structure S1 at a voltage of 4.25 kV, and this snap-through from the stiff regime to the soft regime supports the bistability hypothesis. Introducing a slight pre-bending bias may be used to tailor the response of the structures to either produce large deflections (soft regime) or large bending moments (stiff regime).

In addition to the parallel electrode structures, two zipper electrode prototypes were manufactured and tested. The first one (shallow zipper) features the same geometry as structures S1 to S8, i.e., r₀=15 mm and α₀=16 deg. The second structure (tall zipper) features a significantly taller cell cross-section, with a radius r₀=7 mm and opening angle α₀=60 deg. Both zipper prototypes use a GFRP/Kapton laminate similar to 800b and 800c in FIGS. 8B and 8C, except that the copper foil is replaced by a 3 μm thick gold foil over the entire open cell region. Moreover, the polyimide layer is wider than the glass fiber ply and electrodes to provide protection against arcing. These extra polyimide “wings” do not contribute to the overall bending stiffness of the laminate. Finally, conductive tape is integrated between the GFRP and Kapton plies to connect the electrodes.

The results of these two experiments are shown in FIG. 9B. The shallow zipper electrode curve shows a steeper increase in deflection compared to the parallel electrode curve. For an applied voltage of 6 kV, the zipper structure produces a central deflection of δ=0.25 mm as opposed to about 0.2 mm for the parallel electrode. At a critical voltage of 6.3 kV, an electrostatic tribolayer forms on the polyimide insulation which abruptly stops the increase in deflection. Finally, the tall zipper exhibits a much more gradual increase in deflection, than the parallel electrode structures and shallow zipper, and require twice as much voltage as the parallel electrodes to produce comparable deflections. However, the tall zipper exhibits a quadratic increase in deflection even for higher voltages. A change of regime is observed at a voltage of 13.3 kV, which may also be explained by the formation of an electrostatic tribolayer. Since the cross-section is taller, the average electric field strength in the cells is reduced, which delays the generalized breakdown of the air and delay the appearance of the polyimide surface charging.

FIG. 10 illustrates a deflection of a cell 1010 when an upper flat region has a slight convex pre-bend. Upon exposure to compressive forces 1030a and 1030b, the upper portion of cell 1110 bows upwards, giving the cell a bowed shape 1020. This cell provides less resistance to compressive forces compared to the “stiff” regime and therefore exhibits “soft” bending behavior. This is also defined as a “soft” regime.

FIG. 11 illustrates a deflection of a cell 1110 when an upper flat region has a slight concave pre-bend. Upon exposure to compressive forces 1130a and 1130b, the upper portion of cell 1110 bows downwards giving the cell a shape 1120. This cell provides increased resistance to compressive forces compared to the soft regime and therefore exhibits “stiff” bending behavior. This is also defined as a “stiff” regime.

FIG. 12A illustrates a square lattice arranged in the shape of a spherical cap by selectively applying a voltage difference to individual lenticular cells of electrostatic lattice 1200. If cells are individually addressable, this type of architecture can achieve multiple target shapes (saddle, cylinder). In an embodiment, an electrostatic structure may include a plurality of electrostatic ribs. For example, electrostatic lattice 1200 may include a plurality of electrostatic ribs such as electrostatic ribs 1210a-1, 1210a-2, 1210a-3, 1210a-4, 1210a-5, and 1210a-6. Each electrostatic rib may include a bilayer of lenticular cells in an arrangement analogous to structure arrangement 200a and/or electrostatic structure 305. Each lenticular cell of electrostatic lattice 1200 may be addressed individually. In other words, each lenticular cell that includes a pair of electrodes may have a voltage difference applied between the pair of electrodes in order to controllably deform the lattice in a predetermined manner. An exemplary electrostatic lattice may have a bilayer structure, trilayer structure, or any suitable structure.

FIG. 12B shows the evolution of the radius of curvature of electrostatic lattice 1200 as a function of applied voltage. In an embodiment, each lenticular cell of a lower layer of electrostatic lattice 1200 may include a pair of electrodes. FIG. 12B illustrates a first bending arrangement and resulting radius of curvature for each pair of electrodes biased to a voltage indicated on the horizontal axis.

### Manufacturing

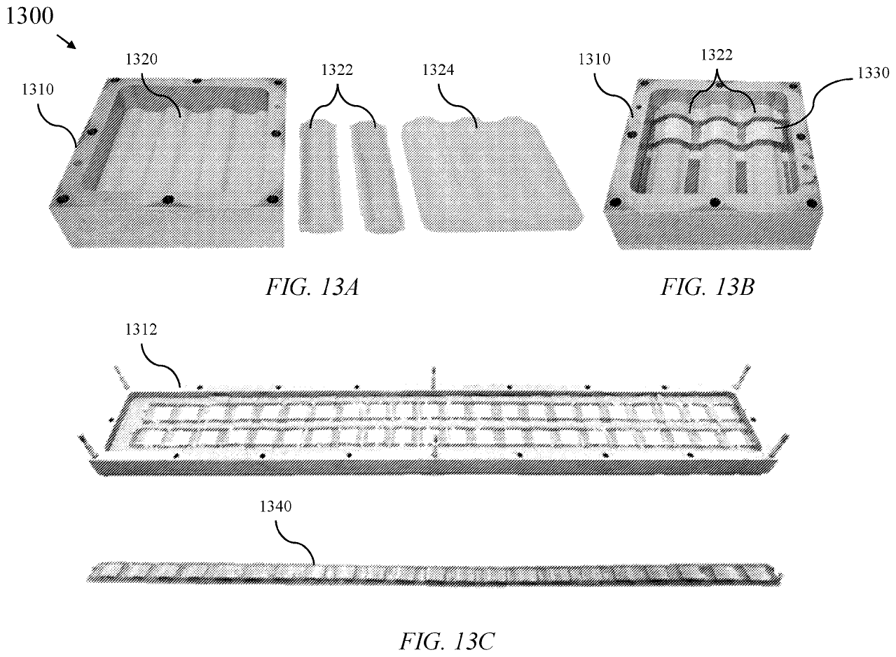

FIG. 13A illustrates a system 1300 for manufacturing electrostatic structures. System 1300 may include mold 1310. Mold 1310 may be made of steel, aluminum, or any suitable molding material such as metal or ceramic. Mold 1310 may be configured to receive one or more silicone mold inserts 1320, 1322, and 1324, which may define a shape of an electrostatic structure by providing support for one or more flexible structure layers prior to mold activation. FIG. 13B illustrates a layup inside of mold 1310 prior to mold closure and heating steps. One or more silicone mold inserts 1320, 1322, and 1324 are disposed within mold 1310 and layup 1330 is placed in the appropriate location on and/or between mold inserts 1320, 1322, and 1324. The mold is then closed and the mold is heated. The matrix material in layup 1330 sets and/or bonds with additional layups, forming an electrostatic structure.

FIG. 13C illustrates a mold 1312 for creating electrostatic thin shell structures and large lattices. To create the 1 m long silicone mold shown in FIG. 13C, a foam mold negative is machined by a hot wire foam cutter. This long mold has successfully been used to create the electrostatic structure 1340 with zipper electrode structure shown in FIG. 13C, which features the same cross-section geometry as the electrostatic structure shown in FIG. 8B.

### Operational Method

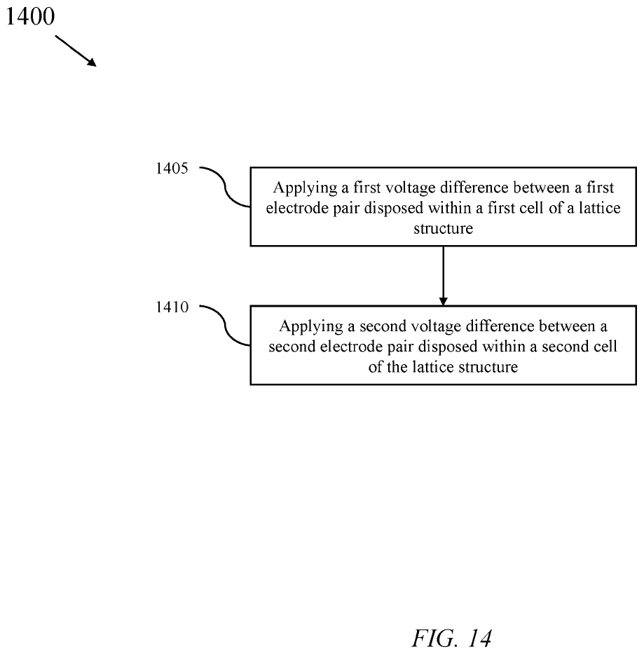

FIG. 14 illustrates a method 1400 for shaping a lattice structure. Method 1400 includes blocks 1405 and 1410.

At block 1405, a first voltage difference between a first electrode pair disposed within a first cell of a lattice structure is applied by a voltage source. The first cell is disposed within a first layer of a bilayer structure. The first voltage difference alterably defines a length associated with the lattice structure and a height associated with the lattice structure. The first cell may optionally be a lenticular cell. The first voltage difference may be about 0 kV to about 30 kV, such as about 3 kV to about 25 kV, and more preferably about 5 kV to about 20 kV.

At block 1410, a second voltage difference between a second electrode pair disposed within a second cell of a lattice structure is applied by a voltage source. The second cell is disposed within the first layer of the bilayer structure. The second voltage difference alterably defines a length associated with the lattice structure and a height associated with the lattice structure. The second cell may optionally be a lenticular cell. The second voltage difference may be about 0 kV to about 30 kV, such as about 3 kV to about 25 kV, and more preferably about 5 kV to about 20 kV.

The first voltage and the second voltage may be substantially equal. Alternatively, the first voltage and the second voltage may differ, e.g., by more than 5%. The first voltage and second voltage may differ, with the larger voltage exceeding the smaller voltage by about 1% to about 300%, including about 5% to about 200%, for example about 15% to 150%, and more preferably about 35% to about 80%.

### CONCLUSION

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. An electrostatic structure, the structure comprising:
a first flexible structure layer;
a second flexible structure layer attached to the first flexible structure layer at a first attachment point and at a second attachment point, the second attachment point being separated from the first attachment point to form a lenticular cell;
a first electrode layer attached to the first flexible structure layer;
a second electrode layer attached to the second flexible structure layer; and
a power supply electrically coupled to the first electrode layer and the second electrode layer and configured to apply a voltage difference between the first electrode layer and the second electrode layer;
wherein the first electrode layer and the second electrode layer are configured to alterably define a separation distance between at least a first portion of the first flexible structure layer and a second portion of the second flexible structure layer based on the voltage difference.

2. The structure of claim 1, further comprising an insulating layer attached to at least one of the first flexible structure layer, the second flexible structure layer, the first electrode layer, or the second electrode layer.

3. The structure of claim 1, wherein each of the first flexible structure layer and the second flexible structure layer comprises a fiber-reinforced composite.

4. The structure of claim 3, wherein the fiber-reinforced composite comprises a glass fiber reinforced plastic.

5. The structure of claim 1, wherein the first flexible structure layer and the second flexible structure layer are attached to each other at a plurality of locations to form a deformable lattice.

6. The structure of claim 1, wherein the voltage difference is between about 0 V and about 30 kV.

7. The structure of claim 5, wherein the first flexible structure layer and the second flexible structure layer define a lenticular shape based on the voltage difference.

8. The structure of claim 1, wherein the first electrode layer is disposed substantially parallel to the second electrode layer.

9. The structure of claim 1, wherein the first electrode layer extends to a curved portion of the first flexible structure layer and the second electrode layer extends to a curved portion of the second flexible structure layer.

10. The structure of claim 1, wherein the structure further comprises a tessellated repetition of lenticular cells.

11. The structure of claim 10, wherein the tessellated repetition comprises at least two layers of lenticular cells arranged in a bilayer structure.

12. A lattice structure, the lattice structure comprising:
a plurality of cells, the plurality of cells comprising two or more flexible structure layers, each flexible structure layer of the two or more flexible structure layers being attached to at least one other flexible structure layer at a first point and at a second point separated from the first point;
one or more electrode pairs disposed within one or more of the plurality of cells; and
a voltage source communicatively coupled to the one or more electrode pairs and configured to alterably define a shape of the lattice structure based on a voltage difference applied between the one or more electrode pairs.

13. The lattice structure of claim 12, wherein the plurality of cells are arranged in a bilayer structure.

14. The lattice structure of claim 13, wherein the one or more electrode pairs are disposed within a first layer of the bilayer structure.

15. The lattice structure of claim 12, wherein each cell of the plurality of cells is attached to another cell of the plurality of cells.

16. The lattice structure of claim 12, wherein the cells comprise lenticular cells.

17. The lattice structure of claim 12, wherein the cells are arranged in a tessellated pattern.

18. A method for shaping a lattice structure, the method comprising:
applying, by a voltage source, a first voltage difference between a first electrode pair disposed within a first cell of the lattice structure;
applying, by the voltage source, a second voltage difference between a second electrode pair disposed within a second cell of the lattice structure;
wherein:
the first cell and the second cell are disposed within a first layer of a bilayer structure; and
the first voltage difference and the second voltage difference alterably define a length associated with the lattice structure and a height associated with the lattice structure.

19. The method of claim 18, wherein the first cell and the second cell comprise lenticular cells.

20. The method of claim 18, wherein the first voltage difference and the second voltage difference are substantially equal.
